(19) United States
(12) Patent Application Publication
(10) Pub. No.: US 2012/0314039 A1
(43) Pub. Date: Dec. 13, 2012

(54) 3D IMAGE ACQUISITION APPARATUS EMPLOYING INTERCHANGABLE LENS

(75) Inventors: Jang-woo YOU, Yongin-si (KR); Yong-hwa PARK, Yongin-si (KR); Won-ki LEE, Yongin-si (KR); Yong-chul CHO, Suwon-si (KR); Mi-jeong SONG, Suwon-si (KR)

(73) Assignee: SAMSUNG ELECTRONICS CO., LTD., Suwon-si (KR)

(21) Appl. No.: 13/462,522

(22) Filed: May 2, 2012

(30) Foreign Application Priority Data
Jun. 7, 2011 (KR) 10-2011-0054642

(51) Int. Cl. H04N 15/00

(52) U.S. Cl. 348/49; 348/46; 348/E15.001

(57) ABSTRACT

A three-dimensional (3D) image acquisition apparatus is provided. The 3D image acquisition apparatus includes: an interchangeable lens unit comprising a lighting unit that irradiates light toward an object, a color image lens unit that forms a color image of the object, and a depth image capturing unit that comprises a depth image lens unit for obtaining depth image information relating to the object; and a main body comprising a first image sensor that converts an optical image formed by the color image lens unit into an electric signal and an image processor that forms a 3D image using the electric signal of the first image sensor and depth information of the depth image capturing unit, wherein the interchangeable lens unit is detachable from the main body.

### CROSS-REFERENCE TO RELATED APPLICATIONS

This application claims priority from Korean Patent Application No. 10-2011-0054642, filed on Jun. 7, 2011, in the Korean Intellectual Property Office, the disclosure of which is incorporated herein by reference in its entirety.

### BACKGROUND

1. Field

The present disclosure relates to a three-dimensional (3D) image acquisition apparatus employing an interchangeable lens.

2. Description of the Related Art

Recently, distribution of image forming optical devices has been rapidly expanding. These image forming optical devices include digital cameras that use a solid imaging device, such as, for example, a charge coupled device (CCD) or a complementary metal-oxide semiconductor (CMOS) for converting an optical image into an electric signal.

Digital cameras may be classified into advanced digital single lens reflex (DSLR) cameras and low-cost compact digital cameras. Since mirrorless cameras that have advantages of both types of cameras have been introduced, such cameras have been developed.

In addition, because of recent advances in 3D display apparatuses and increasing demand therefor, the significance of 3D content is becoming increasingly important. Accordingly, research relating to 3D cameras that enable users to create 3D content on their own is increasing. 3D cameras obtain 3D image information by using two-dimensional (2D) red-green-blue (RGB) color image information. 3D image information may be obtained using, for example, one or both of a stereoscopic method and a depth measurement method. According to the stereoscopic method, an image for a left eye and an image for a right eye are obtained using two lenses and two sensors, and a sense of depth is recognized by a human brain. According to the depth measurement method, 3D distance information is directly measured, for example, using triangulation or time-of-flight (TOF).

### SUMMARY

Provided is a 3D image acquisition apparatus employing an interchangeable lens.

Additional aspects will be set forth in part in the description which follows and, in part, will be apparent from the description, or may be learned by practice of the presented embodiments.

According to an aspect of one or more exemplary embodiments, a 3D image acquisition apparatus includes: an interchangeable lens unit including a lighting unit that irradiates light toward an object, a color image lens unit that uses the irradiated light to form a color image of the object, and a depth image capturing unit that includes a depth image lens unit for obtaining depth image information relating to the object; and a main body including a first image sensor that converts an optical image formed by the color image lens unit into an electric signal and an image processor that forms a 3D image using the electric signal from the first image sensor and depth information of the depth image capturing unit, wherein the interchangeable lens unit is detachable from the main body.

The depth image capturing unit may include: the depth image lens unit that focuses light irradiated by the lighting unit toward the object and reflected by the object; and a second image sensor that senses the light focused by the depth image lens unit.

The lighting unit may include a light source that irradiates infrared light.

The 3D image acquisition apparatus may further include a light modulator that modulates light which passes through the depth image lens unit.

The light modulator may be one of a reflective type modulator and a transmissive type modulator.

The second image sensor may include a depth image sensor that directly senses depth information relating to the object from the sensed light focused by the depth image lens unit.

The lighting unit may irradiate patterned light toward the object. The lighting unit may include a light source and a diffractive optical element that diffracts light irradiated by the light source.

The lighting unit may irradiate light toward the object by scanning. The lighting unit may include a light source, a collimation lens that collimates light irradiated by the light source, and a scanning mirror which scans the collimated light. The second image sensor may include a point sensor.

An optical axis of the color image lens unit may be disposed not to be the same as an optical axis of the main body.

The color image lens unit may include: a left lens that forms an image for viewing by a left eye; and a right lens that forms an image for viewing by a right eye.

The left lens may use a first half region of the first image sensor and the right lens uses a second half region of the first image sensor.

An optical axis of the depth image lens unit may be disposed to be the same as an optical axis of the main body.

One of the left lens and the right lens may function as the depth image lens unit. The interchangeable lens unit may further include a beam splitter that splits light which passes through the one of the left lens and the right lens disposed to function as the depth image lens unit into a first light stream which is directed toward the first image sensor and a second light stream which is directed toward the second image sensor.

An optical axis of the color image lens unit may be disposed to be the same as an optical axis of the main body. An optical axis of the depth image lens unit may be disposed to be the same as an optical axis of the color image lens unit.

The color image lens unit and the depth image lens unit may share an imaging lens that simultaneously forms a color image and a depth image of the object. The 3D image acquisition apparatus may further include a beam splitter that splits the color image and the depth image formed by the imaging lens and directs the color image toward the first image sensor and directs the depth image toward the second image sensor.

The color image lens unit may further include a relay lens that transmits the color image formed by the imaging lens to the first image sensor.

The depth image lens unit may further include a converting lens that enlarges or reduces the depth image formed by the imaging lens to a size corresponding to the second image sensor.

The interchangeable lens unit may further include: a first interchangeable lens section that includes the imaging lens; and a second interchangeable lens section that includes the lighting unit, the beam splitter, the relay lens, the converting lens, and the second image sensor, wherein the first interchangeable lens section is detachable from the second interchangeable lens section.

### BRIEF DESCRIPTION OF THE DRAWINGS

These and/or other aspects will become apparent and more readily appreciated from the following description of exemplary embodiments, taken in conjunction with the accompanying drawings of which:

FIG. 1 is a block diagram of a 3D image acquisition apparatus according to an exemplary embodiment;

FIG. 2 is a schematic cross-sectional view of a 3D image acquisition apparatus according to an exemplary embodiment;

FIGS. 3, 4, and 5 show respective modifications of the 3D image acquisition apparatus shown in FIG. 2;

FIG. 6 is a schematic cross-sectional view of a 3D image acquisition apparatus according to another exemplary embodiment;

FIG. 7 is a schematic cross-sectional view of a 3D image acquisition apparatus according to another exemplary embodiment;

FIG. 8 is a schematic cross-sectional view of a 3D image acquisition apparatus according to another exemplary embodiment;

FIG. 9 is a schematic cross-sectional view of a 3D image acquisition apparatus according to another exemplary embodiment;

FIG. 10 is a schematic cross-sectional view of a 3D image acquisition apparatus according to another exemplary embodiment;

FIG. 11 is a schematic cross-sectional view of a 3D image acquisition apparatus according to another exemplary embodiment; and

FIG. 12 is a schematic cross-sectional view of a 3D image acquisition apparatus according to another exemplary embodiment.

### DETAILED DESCRIPTION

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects of the present description.

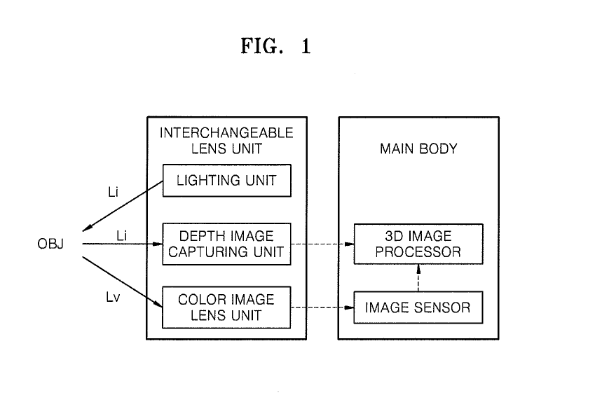

FIG. 1 is a block diagram of a 3D image acquisition apparatus according to an exemplary embodiment.

Referring to FIG. 1, the 3D image acquisition apparatus includes an interchangeable lens unit and a main body from which the interchangeable lens unit is detachable. The interchangeable lens unit includes a color image lens unit that captures a 2D image of an object OBJ and a depth image capturing unit that captures a depth image of the object OBJ. In addition, the interchangeable lens unit further includes a lighting unit for irradiating light for capturing the depth image, wherein the irradiated light is distinguishable from visible light Lv, such as, for example, infrared light Li.

The color image lens unit forms an image of the object OBJ obtained from the visible light Lv by using an image sensor. The depth image capturing unit includes a depth image lens unit for forming an image of the object OBJ obtained from the infrared light Li, and may use various methods to obtain depth information. In one such method, for example, infrared light Li reflected by the object OBJ is modulated and the image sensor receives an image obtained from the modulated infrared light Li, and then the depth information may be calculated by using the image. Alternatively, the depth information may directly be measured by using a depth sensor without using a modulator.

The main body includes an image sensor that converts an optical image formed by the color image lens unit into an electric signal, and an image processor that forms a 3D image using the electric signal from the image sensor and depth information obtained by the depth image capturing unit.

Because the depth image capturing unit is disposed in the interchangeable lens unit, the 3D image acquisition apparatus may conveniently form a 3D image without modifying either of the color image lens unit for capturing a 2D image or the main body.

In addition, a large amount of light may be obtained by reducing an f-number of the depth image lens unit, and thus a precise depth image may be obtained by increasing a signal-to-noise ratio (SNR).

Hereinafter, such a 3D image acquisition apparatus will be described in more detail.

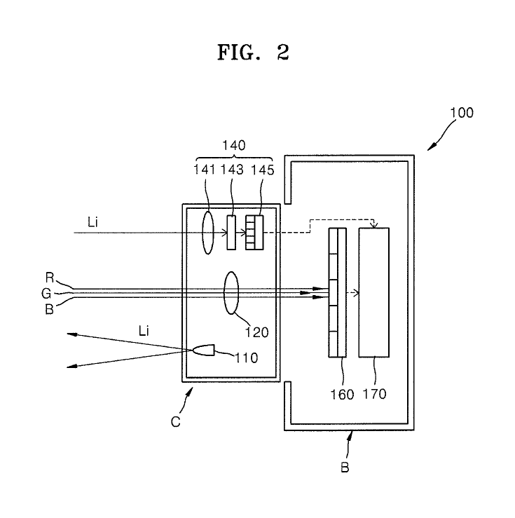

FIG. 2 is a schematic cross-sectional view of a 3D image acquisition apparatus 100 according to an exemplary embodiment.

Referring to FIG. 2, the 3D image acquisition apparatus 100 includes an interchangeable lens unit C and a main body B.

The interchangeable lens unit C includes a light source 110 that irradiates light toward an object, a color image lens unit 120 that forms a color image of the object, and a depth image capturing unit 140 that obtains depth image information relating to the object. The main body B, from which the interchangeable lens unit C is detachable, includes a first image sensor 160 that converts an optical image formed by the color image lens unit 120 into an electric signal, and an image processor 170 that forms a 3D image by using the electric signal from the first image sensor 160 and the depth image information obtained by the depth image capturing unit 140.

The light source 110 may be a part of a lighting unit that irradiates light required to obtain depth image information relating to the object toward the object, and may include at least one of a laser diode (LD), a light emitting diode (LED), a super luminescent diode (SLD), or the like. The light source 110 may irradiate infrared light Li, for example, light having a wavelength within a range of about 750 nm to about 2500 nm. The light source 110 may irradiate light modulated to have a predetermined frequency toward the object. The lighting unit may further include one or more optical members for adjusting a light path or for zooming, in addition to the light source 110.

The color image lens unit 120 forms an image obtained by visible light components red (R), green (G), and blue (B), which are reflected by the object, on the first image sensor 160, thereby enabling 2D image information to be obtained. In FIG. 2, the color image lens unit 120 has a single lens. However, multiple lenses may be used for image forming, aberration correction, or zooming.

The depth image capturing unit 140 includes a depth image lens unit 141 that focuses infrared light Li irradiated from the light source 110 toward the object and reflected by the object, a light modulator 143 that modulates the infrared light Li which passes through the depth image lens unit 141, and a second image sensor 145 that senses the infrared light Li modulated by the light modulator 143. The depth image capturing unit 140 may obtain depth information by, for example, using time-of-flight (TOF) information that includes information pertaining to a time period starting from when the infrared light Li is reflected by the object and ending when the infrared light Li is received by the second image sensor 145.

The depth image lens unit 141 has a single lens in FIG. 2. However, multiple lenses may be used for image forming, aberration correction, or zooming.

The light modulator 143 modulates light reflected by the object to a form suitable for subsequent processes, such as, for example, a process for calculating depth information using TOF. For example, the light modulator 143 may modulate the reflected light to have a frequency that is the same as a modulation frequency of light irradiated from the light source 110, but with a phase difference. According to these modulation conditions, TOF may be calculated from images sensed by the second image sensor 145, and depth information pertaining thereto may be extracted. The light modulator 143 may be a reflective type modulator or a transmissive type modulator. An optical alignment of the depth image capturing unit 140 may vary according to the type of the light modulator 143. The light modulator 143 shown in FIG. 2 is a transmissive type modulator.

On the first image sensor 160, visible light components R, G, and B that are reflected by the object and which pass through the color image lens unit 120 are used to form an image of the object. The first image sensor 160 includes a device that converts an optical image to an electric signal. The first image sensor 160 may include a solid imaging device, such as, for example, a charge coupled device (CCD) or a complementary metal-oxide semiconductor (CMOS).

The image processor 170 forms a 3D image using depth information obtained by the depth image capturing unit 140 and a 2D image obtained by the first image sensor 160.

The 3D image acquisition apparatus 100 may use a contact point that may be used, for example, in a general lens-interchangeable camera to control zooming and focusing in order to control the light source 110 and the depth image capturing unit 140, obtain depth image information, and exchange data. Alternatively, the main body B may include an input-output terminal such as a USB (not shown), and may be connected to the interchangeable lens unit C via a wire so that a control signal may be transmitted and image data may be input and output. The interchangeable lens unit C may further include one or more of a battery, a circuit, a connector for transmitting a signal, or the like.

In the structure shown in FIG. 2, an optical axis of the color image lens unit 120 is disposed to be the same as an optical axis of the main body B. However, the optical axis of the color image lens unit 120 may not be the same as an optical axis of the main body B, for example, for convenience of an arrangement of other elements.

The depth image capturing unit 140 may have various other structures for obtaining depth information, such as, for example, a structure for performing triangulation. As another example, a structure that uses a Kinect-type light coding method such as that developed by Microsoft, or a structure that uses a depth sensor which is capable of directly measuring depth without using a light modulator, such as that developed by PMD Technologies or CSEM, may also be used. A structure for performing mechanical scanning, such as, for example, point scanning or line scanning, may also be used to obtain a depth image of the entire object.

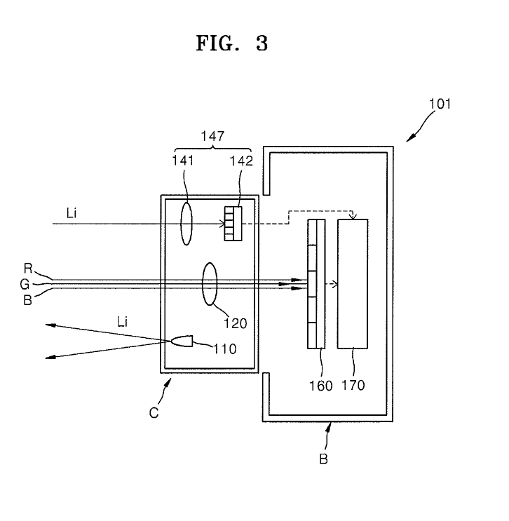

FIGS. 3, 4, and 5 show 3D image acquisition apparatuses 101, 102, and 103 respectively obtained by modifying the 3D image acquisition apparatus 100 of FIG. 2, in which a depth image capturing unit does not include a light modulator.

The 3D image acquisition apparatus 101 of FIG. 3 is distinguished from the 3D image acquisition apparatus 100 of FIG. 2 by the inclusion of a depth image capturing unit 147. In particular, the depth image capturing unit 147 does not include a light modulator, but the depth image capturing unit 147 does include a depth image sensor 142 that directly senses depth information relating to the object from light which is focused by the depth image lens unit 141. Examples of the depth image sensor 142 may include sensors used by PMD Technologies or CSEM.

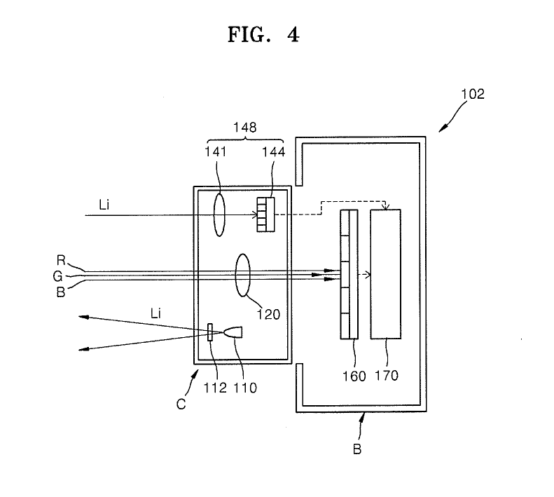

The 3D image acquisition apparatus 102 of FIG. 4 uses a Kinect-type device in order to obtain a depth image. For this, the lighting unit includes the light source 110 and a diffractive optical element 112, and a depth image capturing unit 148 includes the depth image lens unit 141 and a black and white image sensor 144. Patterned light is irradiated to the object using the diffractive optical element 112, and the patterned light, after being reflected by the object, is sensed by the black and white image sensor 144, and then a depth image may be obtained by using light triangulation.

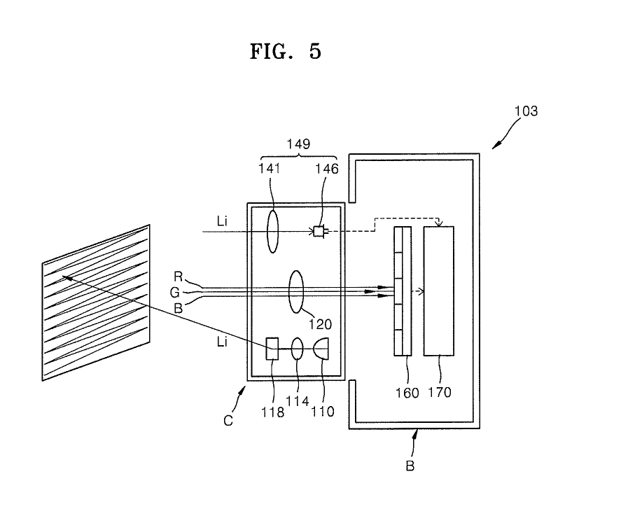

Referring to FIG. 5, in the 3D image acquisition apparatus 103, the lighting unit may include the light source 110, a collimation lens 114, and a scanning mirror 118 to irradiate light toward the object by using a scanning method. For example, light may be irradiated by using raster scanning. A depth image capturing unit 149 includes the depth image lens unit 141 and a point sensor 146, such as, for example, a photodiode (PD) or an avalanche photo diode (APD). For bi-axial scanning to be performed by a scanning mirror 118, a microelectromechanical systems (MEMS) scanning mirror may be used. For example, a single bi-axial rotation mirror or two uni-axial rotation mirrors having rotation axes disposed perpendicularly with respect to one another may be used.

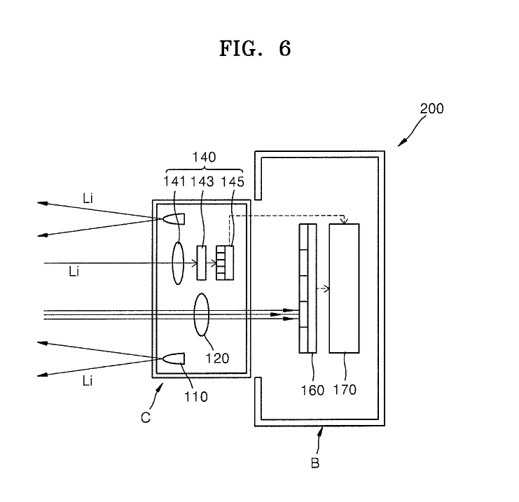

FIG. 6 is a schematic cross-sectional view of a 3D image acquisition apparatus 200 according to another exemplary embodiment.

In the 3D image acquisition apparatus 200, the optical axis of the color image lens unit 120 is disposed not to be same as the optical axis of the main body B. In particular, this distinguishes the 3D image acquisition apparatus 200 shown in FIG. 6 from the 3D image acquisition apparatus 100 shown in FIG. 2. As a result of this arrangement, the color image lens unit 120 may efficiently use only a portion of the first image sensor 160. However, this alignment may be used to change a relative position of the depth image capturing unit 140 within the interchangeable lens unit C when a plurality of light sources 110 are disposed as shown in FIG. 6.

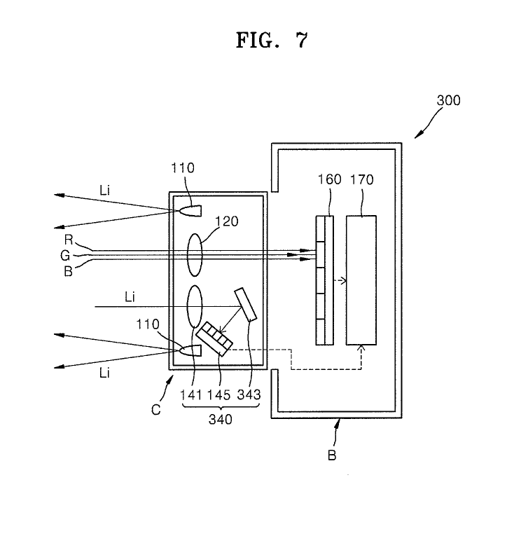

FIG. 7 is a schematic cross-sectional view of a 3D image acquisition apparatus 300 according to another exemplary embodiment.

The 3D image acquisition apparatus 300 is different from the 3D image acquisition apparatus 200 of FIG. 6 in that the depth image capturing unit 340 includes a reflective type light modulator 343.

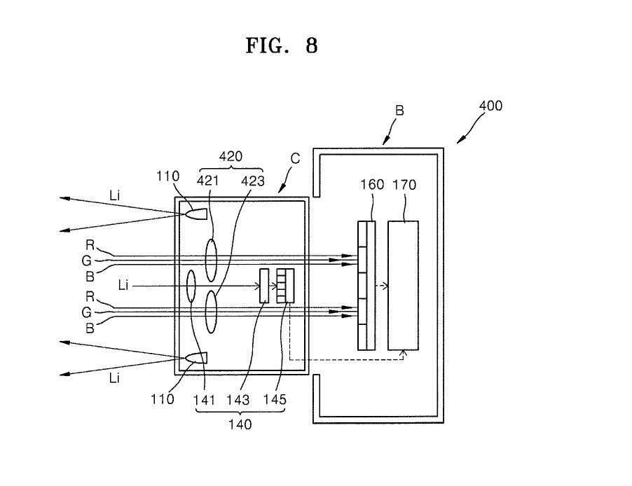

FIG. 8 is a schematic cross-sectional view of a 3D image acquisition apparatus 400 according to another exemplary embodiment.

The 3D image acquisition apparatus 400 simultaneously uses a stereoscopic method and a depth measuring method to form a 3D image.

A color image lens unit 420 includes a left lens 421 for forming an image for viewing by a left eye and a right lens 423 for forming an image for viewing by a right eye. The left lens 421 uses a half region of the first image sensor 160 and the right lens 423 uses approximately the other half region of the first image sensor 160.

In the structure shown in FIG. 8, an optical axis of the color image lens unit 420 is not the same as the optical axis of the main body B, and an optical axis of the depth image lens unit 141 is disposed to be same as the optical axis of the main body B.

The depth image capturing unit 140 includes the depth image lens unit 141, the light modulator 143, and the second image sensor 145. As described above, the depth image capturing unit 140 may obtain depth information using TOF information that is obtained by measuring a time period starting from when infrared light Li is reflected by the object and ending when the infrared light Li is received by the second image sensor 145.

The image processor 170 generates a 3D image using depth information obtained by the depth image capturing unit 140 and left-eye image information and right-eye image information obtained by the first image sensor 160.

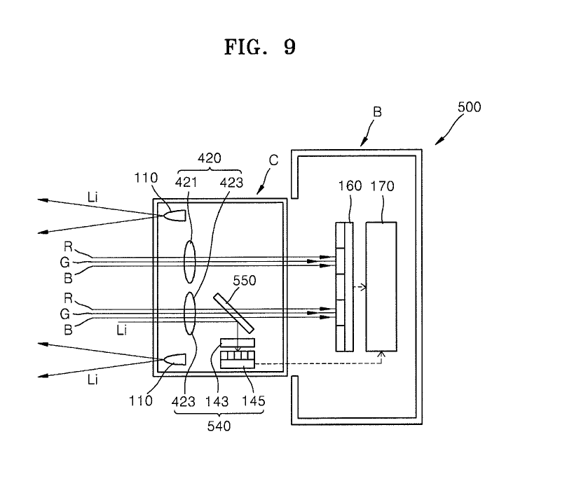

FIG. 9 is a schematic cross-sectional view of a 3D image acquisition apparatus 500 according to another exemplary embodiment.

The 3D image acquisition apparatus 500 is different from the 3D image acquisition apparatus 400 shown in FIG. 8 in that one of the left lens 421 and the right lens 423 functions as a depth image lens unit. As shown in FIG. 9, a depth image capturing unit 540 includes the right lens 423, the light modulator 143, and the second image sensor 145. Accordingly, the interchangeable lens unit C further includes a beam splitter 550 that splits light which passes through the right lens 423, which is disposed to function as the depth image lens unit, and directs a first light stream toward the first image sensor 160 and directs a second light stream toward the second image sensor 145. In particular, among light reflected by the object, visible light components R, G, and B are directed toward the first image sensor 160 by the beam splitter 550, and infrared light Li is directed toward the second image sensor 145 by the beam splitter 550.

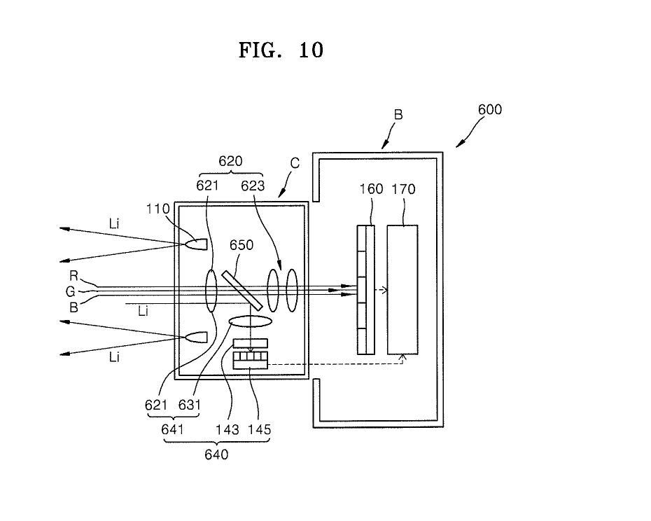

FIG. 10 is a schematic cross-sectional view of a 3D image acquisition apparatus 600 according to another exemplary embodiment.

In the 3D image acquisition apparatus 600, an optical axis of the color image lens unit 620 is the same as the optical axis of the main body B. In addition, an optical axis of the depth image capturing unit 640 is disposed to be the same as the optical axis of the color image lens unit 620. In particular, the optical axis of the color image lens unit 620 and an optical axis of a depth image lens unit 641 are identical to each other and they share an imaging lens 621 that simultaneously forms a color image and a depth image of the object.

Because view points of a color image and a depth image are the same in the co-axial structure of apparatus 600, separate view point correction may be reduced. According to this alignment, the interchangeable lens unit C further includes a beam splitter 650 that splits the color image and the depth image formed by the imaging lens 621 and directs the color image toward the first image sensor 160 and directs the depth image toward the second image sensor 145. The color image lens unit 620 further includes a relay lens 623 that transmits the color image formed by the imaging lens 621 to the first image sensor 160. In addition, the size of the first image sensor 160 may be different from the size of the second image sensor 145. Accordingly, the depth image lens unit 641 includes a converting lens 631 that enlarges or reduces the depth image formed by the imaging lens 621 to a size corresponding to the second image sensor 145.

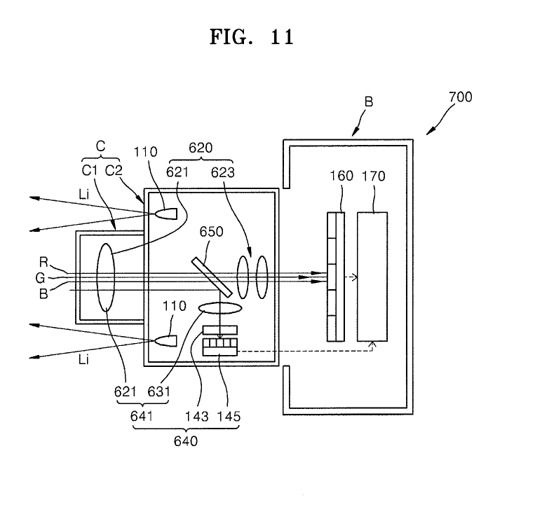

FIG. 11 is a schematic cross-sectional view of a 3D image acquisition apparatus 700 according to another exemplary embodiment.

The 3D image acquisition apparatus 700 is different from the 3D image acquisition apparatus 600 shown in FIG. 10, in that the imaging lens 621 shared by the depth image lens unit 641 and the color image lens unit 620 is interchangeable. In particular, the interchangeable lens unit C includes a first interchangeable lens section C1 that includes the imaging lens 621 and a second interchangeable lens section C2 that includes the light source 110, the beam splitter 650, the relay lens 623, the converting lens 631, the light modulator 143, and the second image sensor 145. The first interchangeable lens section C1 may be detached from the second interchangeable lens section C2.

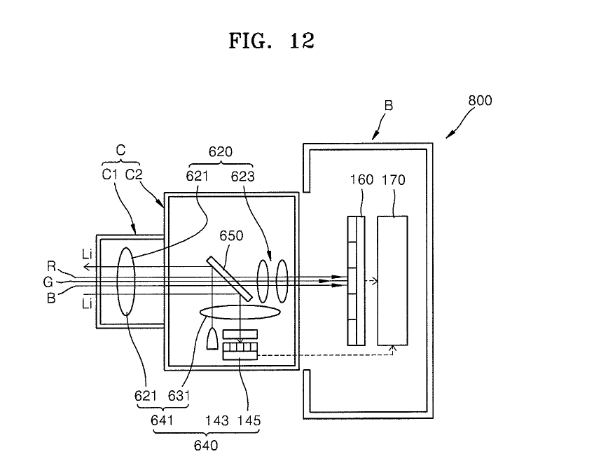

FIG. 12 is a schematic cross-sectional view of a 3D image acquisition apparatus 800 according to another exemplary embodiment.

The 3D image acquisition apparatus 800 is different from the 3D image acquisition apparatus 700 shown in FIG. 11 in an alignment of the light source 110. In particular, the path of a light irradiated toward the object is coaxial with the optical axis of the color image lens unit 620.

The depth image capturing units of the 3D image acquisition apparatuses shown in FIGS. 6 to 12 include a light modulator, but the present inventive concept is not limited thereto. For example, the 3D image acquisition apparatuses shown in FIGS. 6 to 12 may instead include a depth image capturing unit and a modified lighting unit as described with reference to FIGS. 3, 4, and 5.

The optical alignments of the 3D image acquisition apparatuses described above are examples of a structure in which a depth image capturing unit for obtaining depth image information relating to an object is embodied as an interchangeable lens. Thus, the structures of the 3D image acquisition apparatuses are not limited thereto, and the types, numbers, and alignments of lenses may vary, and other elements such as an optical member for changing an optical path may further be used.

Because the depth image capturing unit is embodied as an interchangeable lens which is detached from a main body of each respective apparatus, the 3D image acquisition apparatuses may conveniently form a 3D image without modifying either of a color image lens unit for capturing a 2D image or the main body.

While exemplary embodiments have been particularly shown and described, it will be understood by those of ordinary skill in the art that various changes in form and details may be made therein without departing from the spirit and scope of the present inventive concept as defined by the appended claims. It should be understood that the exemplary embodiments described herein should be considered in a descriptive sense only and not for purposes of limitation. Descriptions of features or aspects within each embodiment should typically be considered as available for other similar features or aspects in other embodiments. Therefore, the scope of the present inventive concept is defined not by the detailed description but by the appended claims, and all differences within the scope will be construed as being included in the present disclosure.

What is claimed is:

1. A three-dimensional (3D) image acquisition apparatus comprising:
an interchangeable lens unit comprising a lighting unit that irradiates light toward an object, a color image lens unit that uses the irradiated light to form a color image of the object, and a depth image capturing unit that comprises a depth image lens unit which obtains depth image information relating to the object; and
a main body comprising a first image sensor that converts an optical image formed by the color image lens unit into an electric signal and an image processor that forms a 3D image using the electric signal from the first image sensor and depth information obtained by the depth image capturing unit,
wherein the interchangeable lens unit is detachable from the main body.

2. The 3D image acquisition apparatus of claim 1, wherein the depth image capturing unit further comprises:
the depth image lens unit that focuses light irradiated by the lighting unit toward the object and reflected by the object; and
a second image sensor that senses the light focused by the depth image lens unit.

3. The 3D image acquisition apparatus of claim 2, wherein the lighting unit comprises a light source that irradiates infrared light.

4. The 3D image acquisition apparatus of claim 2, further comprising a light modulator that modulates light which passes through the depth image lens unit.

5. The 3D image acquisition apparatus of claim 4, wherein the light modulator is one of a reflective type modulator and a transmissive type modulator.

6. The 3D image acquisition apparatus of claim 2, wherein the second image sensor comprises a depth image sensor that directly senses depth information relating to the object from the sensed light.

7. The 3D image acquisition apparatus of claim 2, wherein the lighting unit irradiates patterned light toward the object.

8. The 3D image acquisition apparatus of claim 7, wherein the lighting unit comprises a light source and a diffractive optical element that diffracts light irradiated by the light source.

9. The 3D image acquisition apparatus of claim 2, wherein the lighting unit irradiates light toward the object by scanning.

10. The 3D image acquisition apparatus of claim 9, wherein the lighting unit comprises a light source, a collimation lens that collimates light irradiated by the light source, and a scanning mirror which scans the collimated light.

11. The 3D image acquisition apparatus of claim 10, wherein the second image sensor comprises a point sensor.

12. The 3D image acquisition apparatus of claim 1, wherein an optical axis of the color image lens unit is disposed not to be the same as an optical axis of the main body.

13. The 3D image acquisition apparatus of claim 12, wherein the color image lens unit comprises:
a left lens that forms an image for viewing by a left eye; and
a right lens that forms an image for viewing by a right eye.

14. The 3D image acquisition apparatus of claim 13, wherein the left lens uses a first half region of the first image sensor and the right lens uses a second half region of the first image sensor.

15. The 3D image acquisition apparatus of claim 13, wherein an optical axis of the depth image lens unit is disposed to be the same as an optical axis of the main body.

16. The 3D image acquisition apparatus of claim 13, wherein one of the left lens and the right lens functions as the depth image lens unit.

17. The 3D image acquisition apparatus of claim 16, wherein the depth image capturing unit comprises a second image sensor which senses light focused by the depth image lens unit, and
wherein the interchangeable lens unit further comprises a beam splitter that splits light which passes through the depth image lens unit into a first light stream which is directed toward the first image sensor and a second light stream which is directed toward the second image sensor.

18. The 3D image acquisition apparatus of claim 2, wherein an optical axis of the color image lens unit is disposed to be the same as an optical axis of the main body.

19. The 3D image acquisition apparatus of claim 18, wherein an optical axis of the depth image lens unit is disposed to be the same as an optical axis of the color image lens unit.

20. The 3D image acquisition apparatus of claim 19, wherein the color image lens unit and the depth image lens unit share an imaging lens that simultaneously forms a color image and a depth image of the object.

21. The 3D image acquisition apparatus of claim 20, further comprising a beam splitter that splits the color image and the depth image formed by the imaging lens and directs the color image toward the first image sensor and directs the depth image toward the second image sensor.

22. The 3D image acquisition apparatus of claim 21, wherein the color image lens unit further comprises a relay lens that transmits the color image formed by the imaging lens to the first image sensor.

23. The 3D image acquisition apparatus of claim 22, wherein the depth image lens unit further comprises a converting lens that enlarges or reduces the depth image formed by the imaging lens to a size corresponding to the second image sensor.

24. The 3D image acquisition apparatus of claim 23, wherein the interchangeable lens unit further comprises:
a first interchangeable lens section that comprises the imaging lens; and
a second interchangeable lens section that comprises the lighting unit, the beam splitter, the relay lens, the converting lens, and the second image sensor,
wherein the first interchangeable lens section is detachable from the second interchangeable lens section.
